(19) United States
(12) Patent Application Publication
(10) Pub. No.: US 2021/0107175 A1
(43) Pub. Date: Apr. 15, 2021

(54) MACHINING APPARATUS AND MACHINING METHOD

(71) Applicant: HOMAG GMBH, Schopfloch (DE)

(72) Inventor: Volker SCHMIEDER, Mössingen (DE)

(21) Appl. No.: 16/613,688

(22) PCT Filed: May 14, 2018
(86) PCT No.: PCT/EP2018/062349

§ 371 Date: Nov. 14, 2019

(30) Foreign Application Priority Data
May 18, 2017 (DE) 10 2017 208 422.7

(51) Int. Cl. B27M 1/08; B27C 1/14; B27C 1/12; B27G 11/00

(52) U.S. Cl. CPC B27M 1/08; B27G 11/00; B27C 1/12; B27C 1/14

(57) ABSTRACT

The invention relates to a machining apparatus, in particular for wooden workpieces in the form of panels or bars, having at least one tool for contouring at least one side face of the workpiece by cutting and having a transport device for creating a relative movement between the workpiece and the at least one tool for machining the workpiece with the at least one tool, and having a device for applying material to the workpiece, wherein the device for applying material to the workpiece is arranged downstream of the at least one tool for contouring, in particular in the transporting direction of the transport device.

### TECHNICAL FIELD

The invention relates to a machining device, in particular for board-shaped and/or bar-shaped workpieces from lumber.

### PRIOR ART

Planing devices for lumber workpieces are known in the prior art. Usually board-shaped or bar-shaped workpieces from lumber are planed herein. Board-shaped workpieces herein tend to be flat elongate workpieces having an extent in the width direction which is larger by a multiple than the extent in the depth or thickness direction, respectively. Furthermore, bar-shaped workpieces tend to be elongate workpieces having an extent in the width direction which corresponds approximately to an extent in the depth or thickness direction, respectively.

Such planing devices plane the workpieces on at least one side along an advancing direction along which the workpieces are transported on tools of the planing device. After the planing, the workpieces are usually retrieved from the planing device by an operative, stored and optionally again fed to a further production or processing step, respectively, by an operative, on another downstream device. The planed workpieces herein are potentially damaged or incorrectly fed to the further processing device, this leading to rejects and thus to increased costs which are to be avoided.

### DISCLOSURE OF THE INVENTION, OBJECT, ACHIEVEMENT, ADVANTAGES

It is the object of the present invention to achieve a machining device which is improved in comparison to the prior art and is nevertheless constructed in a simple and cost-effective manner. It is also the object to achieve a method for machining a workpiece by way of a machining device, said method permitting simple and cost-effective machining.

This object in terms of the machining device is achieved by the features of claim 1.

One exemplary embodiment of the invention relates to a machining device, in particular for board-shaped or bar-shaped workpieces from lumber, having at least one tool for the subtractive contouring of at least one lateral face of the workpiece, and having a transport installation for generating a relative movement between the workpiece and the at least one tool for machining the workpiece by way of the at least one tool, and having an installation for applying material to the workpiece, wherein the installation for applying material to the workpiece is disposed downstream, in particular in the transporting direction of the transport installation, of the at least one tool for contouring.

The feature “a workpiece from lumber” herein means in particular a workpiece from solid lumber such as a lumber beam or a lumber board from solid lumber. Optionally, lumber-like materials which at least in part contain lumber, such as chip boards, multi-component materials or sandwich materials, can also be used.

The tool can be a planing tool, a routing tool and/or a sanding tool. Correspondingly, the machining device can be a planing device and/or a routing device and/or a sanding device. This hereafter applies generally without a respective repetition being required.

The transport device serves for generating a relative movement of the workpiece relative to at least one tool. The workpiece herein can be transported and thus repositioned while the at least one tool is not repositioned. Alternatively, the at least one tool can also be transported and thus repositioned while the workpiece is not repositioned. Finally, both the workpiece as well as the at least one tool can be repositioned.

On account thereof, the workpiece in the case of one advantageous exemplary embodiment is transported in particular continuously, wherein said workpiece is contoured and subsequently in the workpiece flow is provided with the material which is applied to at least one surface of the workpiece.

According to one concept according to the invention, it is advantageous in the case of one exemplary embodiment when the transport installation transports the workpiece in a transporting direction, and/or the transport installation transports the at least one tool.

It is also advantageous when the transport installation guides the material to the installation for applying material, and/or past the installation for applying material, so as to apply a material to the workpiece.

It is furthermore also advantageous when the transport installation has holding means for holding the workpiece during the transportation and/or during machining of at least one of the lateral faces of the workpiece.

It is particularly preferable herein when the machining of the workpiece on up to four lateral faces takes place by means of a planing installation, a four-side molder and/or trenching installation and/or router installation and/or sanding installation. Depending on the requirement, the workpiece can thus be machined, for instance subtractively machined on only one lateral face or on more than one of the lateral faces. The workpiece is preferably subtractively contoured on all four lateral faces. To this end, the planing installation preferably has rotating tools such as cutter shafts by means of which the workpiece is subtractively contoured. At least one such cutter shaft can thus be provided per lateral face so as to be able to subtractively contour the respective lateral face according to the parameters. Planing herein means that a smooth, in particular flat, surface is generated, and routing means that a contoured surface having elevations and/or depressions such as grooves or dados, for example, is generated.

It is also particularly advantageous when the installation for applying material to the workpiece has a tape application installation by means of which at least one tape is capable of being applied to the workpiece. On account thereof, an adhesive tape or a masking tape or similar, for example, can be applied to the workpiece, in particular along the entire length of the workpiece. The adhesive tape or the masking tape or another tape herein can be self-adhesive, or to this end an adhesive can be applied prior to the tape being applied. This adhesive can be sprayed, rolled, or otherwise applied, for example.

It is particular advantageous when the tape is an adhesive tape or a masking tape. For example, a pane, such as a glass pane, can be adhesively bonded to the workpiece by means of an adhesive tape, in particular when the workpiece is conjointly connected to other workpieces so as to form a window frame. The adhesive tape can be a one-sided or double-sided adhesive tape.

According to one further aspect of the invention it is also advantageous when the installation for applying material has an installation by means of which a primer and/or an adhesive, etc., are/is capable of being applied to the workpiece. To this end, the material of the primer to be applied can be sprayed, rolled, or otherwise applied as a first layer or as a base coat or as a bonding agent, for example, before a further material such as an adhesive or a tape is subsequently applied.

In the case of one exemplary embodiment it is particularly advantageous when an optional drying facilitation installation is also provided, thus a heater and/or a fan, etc., by means of which the applied material, such as a base coat, a primer, etc., for example, can be more rapidly dried. The heater herein can be an air heater, and infrared heater, a heating radiator, and/or a hotplate, etc., which accelerates the drying of the material on the workpiece. To this end, a fan which transports, for example, hot air to the workpiece so as to accelerate the drying can furthermore also be provided.

Furthermore, it is also advantageous when a cleaning installation for cleaning the workpiece is disposed in the workpiece flow between the planing installation and the installation for applying material. On account thereof, the workpiece can be relieved of residual shavings, for example, prior to the further treatment. The quality of the application of the further material can be improved on account thereof.

It is also particularly advantageous herein when the cleaning installation has a blower nozzle, a suction installation, and/or a brush installation, etc. The blower nozzle can easily remove very small particles, while the brush installation can also easily remove larger parts. A suction installation instead of the blower nozzle can also be advantageously provided.

For the machining of the tape material it is also advantageous when the tape application installation has a cross-cut installation for cross-cutting the tape. On account thereof, the tape can preferably be cross-cut so as to be optimized in terms of length such that the tape is applied at the length as required. This saves further post-machining and reduces costs.

According to one further concept according to the invention it is advantageous when a workpiece storage installation for storing at least one workpiece or a plurality of workpieces is disposed in the workpiece flow between the at least one tool and the installation for applying material. On account thereof, storing of workpieces can take place when this is advantageous, for example in the event of a tape change or a media change, or repair work, etc., thus in particular when the machining device produces at a higher rate than the downstream installation for applying material.

It is also advantageous when the machining device has a machining width for the machining, in particular for the machining by planing and/or routing, such that a maximum workpiece width of 450 mm and or a maximum machining thickness of 350 mm are/is possible.

It is furthermore advantageous when the workpieces to be machined are preferably bar-shaped workpieces, the workpiece width thereof being up to 300 mm and/or the thickness thereof being up to 150 mm.

The object in terms of the method is achieved by the features of claim 15.

One exemplary embodiment of the invention relates to a method for machining a workpiece by way of a machining device in particular as claimed in one of the preceding claims, in which method a workpiece by means of at least one tool is subtractively contoured on at least one lateral face, and subsequently, in particular in the workpiece flow, a material is applied to the workpiece by means of an installation for applying material to the workpiece.

It is advantageous herein when cleaning takes place after the contouring, in particular prior to material being applied to the workpiece. This facilitates the permanent application of the material and enhances the fastening quality.

It is also advantageous when storing the workpiece in a workpiece storage installation takes place after the contouring of a workpiece, wherein upon the retrieval of a workpiece or the workpiece, material is applied to the retrieved workpiece.

Further advantageous design embodiments are described by the description hereunder of the figures and by the dependent claims.

### BRIEF DESCRIPTION OF THE FIGURES OF THE DRAWING

The invention, based on at least one exemplary embodiment, will be explained in more detail hereunder by means of the FIGURES of the drawing in which:

FIG. 1 shows a schematic view of a machining device according to the invention.

### PREFERRED EMBODIMENT OF THE INVENTION

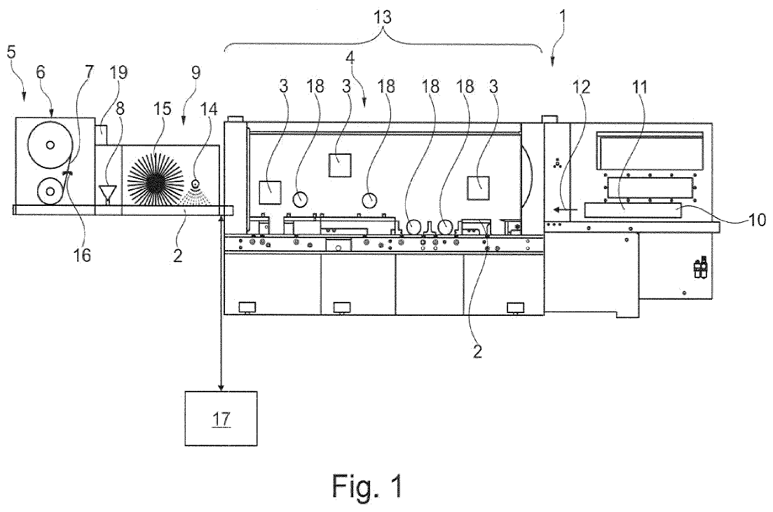

FIG. 1 in a schematic illustration shows a machining device 1, in particular for board-shaped or bar-shaped workpieces 10, in particular from lumber. According to the concept according to the invention, board-shaped workpieces 10 tend to be flat elongate workpieces 10 having an extent in the width direction which is larger by a multiple than the extent in the depth or thickness direction, respectively. Workpieces 10 that tend to be bar-shaped can also be processed, such as strips for windows or door frames, etc., for example, which tend be configured as elongate workpieces 10 having an extent in the width direction which corresponds approximately to an extent in the depth or thickness direction, respectively. The bar-shaped workpieces 10 in the longitudinal direction are typically longer than in the width direction and/or in the depth direction. The workpieces are preferably made from solid lumber or from a lumber-like material. It is particularly preferable herein when the workpieces are bar-shaped workpieces in particular for the construction of windows. The workpieces are preferably approximately up to 300 mm in width and approximately up to 150 mm in thickness.

The machining installation 1 in one exemplary embodiment is equipped with a transport installation 2 for transporting workpieces 10, wherein the transport installation 2 optionally has holding means for holding the workpiece 10 during the transportation and/or during machining of at least one of the lateral faces 11 of the workpiece 10. On account thereof, the respective workpiece 10 can be transported through the machining device 1 and advantageously held for the subtractive machining. For machining all lateral faces 11, a changeover of the holding means can also be provided.

The transport installation 2 advantageously has rolls 18 which transport a workpiece 10 in the transporting direction. Said rolls 18 preferably lie above and/or below and preferably act vertically on a workpiece. Laterally disposed rolls 18 which preferably act horizontally are also advantageously provided. Alternatively or additionally to the rolls 18, other transport means such as a transport belt, etc., can also be provided.

Alternatively, the transport installation 2 can also transport the at least one tool 3, or both the workpiece 10 as well as at least one tool 3, respectively.

On account thereof, the transport installation 2 causes a relative movement between the workpiece 10 and the at least one tool to 3 be generated for machining the workpiece 10 by way of the at least one tool 3.

The machining device 1 accordingly has at least one tool 3 for subtractively contouring or machining, respectively, the workpiece 10. The machining of the workpiece 10 herein can take place on up to four lateral faces 11, for example by means of a planing installation, a four-side molder and/or trenching installation 4, a routing installation and/or a sanding installation, which have/has various tools 3 for machining the desired lateral faces 11 of the workpiece 10.

It can be seen in FIG. 1 that an installation 5 for applying material to the workpiece 10 is disposed downstream of the at least one tool 3 for contouring.

The transport installation 2, or a segment of the transport installation 2 for the workpiece 10, herein traverses in particular also the installation 5 for applying material, and transports the workpiece 10 toward the installation 5 for applying material and/or past the installation 5 for applying material. On account thereof, the material to be applied can be applied during the movement of the workpiece 10 such that efficient processing can take place. Alternatively, the workpiece 10 can also be brought to a standstill before said workpiece 10 is transported onward.

The installation 5 for applying material to the workpiece 10 can be configured as a tape application installation 6, or comprise such a tape application installation 6. At least one prefabricated tape 7 can advantageously be applied to the workpiece 10 by way of such a tape application installation 6. The tape 7 herein can be an adhesive tape or a masking tape or another tape. Said tape as an adhesive tape can be adhesive on one side or both sides. The tape application installation 6 advantageously has a cross-cut installation 16 for cross-cutting the tape 7 so as to be able to cut the tape 7 to the required length. The tape can be self-adhesive, for example, and/or an adhesive can also be applied. An adhesive can also be applied independently of a tape or else without a tape. Said adhesive can be applied by rollers, rolls, sprays, etc., in particular in an upstream installation 8.

Advantageously, the installation 5 for applying material optionally has the installation 8 by means of which a medium such as, for example, a primer, an adhesive, etc., is capable of being applied to the workpiece 10. The medium can be applied by rollers, rolls, sprays, etc. Said installation 8 is optionally disposed upstream of the tape application installation 6 in the direction 12 of the workpiece flow, or else can be provided without such a tape application installation. On account thereof, an in particular further medium can be applied, in particular pre-applied, prior to the application of a tape, or else without the application of a tape. An adhesive bonding face to which an adhesive or a self-adhesive material is applied can optionally be pre-treated with a wood protection agent or in another manner.

In the case of an exemplary embodiment it is particularly advantageous when an optional drying facilitation installation 19 which is preferably configured as a heater and/or a fan, etc., and by means of which the applied material such as, for example a base coat, a primer, etc., can be more rapidly dried by means of the installation 8, is also provided. The heater herein can be an air heater, an infrared heater, a heating radiator and/or a hotplate, etc., which accelerate/accelerates the drying of the material on the workpiece. To this end, a fan which transports, for example, hot air to the workpiece in order for the drying to be accelerated, can furthermore also be provided.

FIG. 1 furthermore shows that a cleaning installation 9 for cleaning the workpiece 10 after said workpiece 10 has been subtractively machined in the machining installation or planing installation 13 and before said workpiece 10 is provided with material, is disposed in the workpiece flow between the machining installation or planing installation 13 having the tools 3 and the installation 5 for applying material. The cleaning installation 9 herein can have a blower nozzle 14, suction installation, and/or a brush installation 15, etc. For example, the blower nozzle 14 blows air such as, for example, compressed air, onto the workpiece 10 and thus cleans the surface of the workpiece 10 in particular in terms of fine elements such as dust or shavings. The brush installation 15 brushes the workpiece and thus cleans the latter, in particular in terms of comparatively coarse elements.

By way of such a machining device it is possible for a method for machining a workpiece 10 to be carried out in which a workpiece is subtractively contoured in a machining installation or a planing installation 13 on at least one lateral face 11 and subsequently in the workpiece flow a material is applied to the workpiece 10 by means of an installation 5 for applying material on the workpiece 10. This is preferably and optionally performed in workpiece flow at a substantially continuous transportation of the workpiece 10. Alternatively, a workpiece store 17 in which workpieces 10 can be temporarily stored can be interposed. Said workpiece store 17 can be optional. If said workpiece store 17 is present, workpieces 10 can be stored therein on demand; alternatively, said workpiece store 17 can also be bypassed on demand such that the machined workpieces 10 are conveyed onward directly without any intermediate storage.

In the case of the method it is particularly preferable when cleaning is performed after the contouring of the workpiece 10, in particular before material is applied to the workpiece 10. This enhances the quality of the application of material, in particular the adhesive capability of the material on the workpiece 10 over a comparatively long period of time.

The machining installation or the planing installation 13, the optional cleaning installation 9, and the installation 5 for applying material accordingly form a unit in which the transport installation 2 transports the workpiece 10 to be machined and to be provided with material in particular through the entire machining device. An operative places the workpiece 10 into the machining device 1 at the infeed side and retrieves said workpiece 10 again at the outfeed side, said workpiece 10 first having been contoured and provided with material. However, in principle this can also be performed in an automated manner. No intervention in the normal production process takes place between the contouring and the provision with material.

The application of material, thus of adhesive tapes and/or of masking tapes, for example, can preferably take place in pre-cut rabbets of the workpiece 10.

The transport installation 2 can be embodied so as to be contiguous or in segments for the respective transportation through the machining installation or planing installation 13, the cleaning installation 9, the workpiece store and/or the installation 5 for applying material. To this end, the provided rolls 18 can be disposed in a corresponding manner so as to be able to transport a workpiece 10 through the machining device, for example.

The machining device 1 and/or the cleaning installation and/or the installation 5 for applying material are/is preferably disposed in a protected room or in a protective housing, optionally while generating defined ambient conditions, in particular in terms of temperature, air humidity, etc.

An adhesive tape according to the invention can be, for example, a polyethylene (PE) foam adhesive tape and/or an acrylate foam adhesive tape or a PE film adhesive tape.

However, the workpieces are preferably and optionally not provided with an edge tape or any other surface coating which is understood to be a lamination and configures a permanent usable surface. The material applied according to the invention is preferably an adhesive tape, an adhesive, and a base coat/primer, or similar, see above.

It is also preferable when the workpiece can optionally be machined such as planed and/or routed on all sides, and/or the workpiece can be provided with the material to be applied on all sides. All sides herein means in particular the four long sides of the workpiece and preferably in particular not the two mutually opposite end sides of the workpiece.

### LIST OF REFERENCE SIGNS

1 Machining device
2 Transport installation
3 Tool
4 Trenching installation
5 Installation
6 Tape application installation
7 Tape
8 Installation
9 Cleaning installation
10 Workpiece
11 Lateral face
12 Direction
13 Machining installation, planing installation
14 Blower nozzle
15 Brush installation
18 Cross-cut installation
17 Workpiece storage installation
18 Roll
19 Drying facilitation installation

1. A machining device, in particular for board-shaped or bar-shaped workpieces from lumber, having at least one tool for the subtractive contouring of at least one lateral face of the workpiece, and having a transport installation for generating a relative movement between the workpiece and the at least one tool for machining the workpiece by way of the at least one tool, and having an installation for applying material to the workpiece, wherein the installation for applying material to the workpiece is disposed downstream, in particular in the transporting direction of the transport installation, of the at least one tool for contouring.

2. The machining device as claimed in claim 1, wherein the transport installation transports the workpiece in a transporting direction, and/or the transport installation transports the at least one tool.

3. The machining device as claimed in claim 1, wherein the transport installation guides the workpiece to the installation for applying material, and/or past the installation for applying material, so as to apply a material to the workpiece.

4. The machining device as claimed in claim 1, wherein the transport installation has holding means for holding the workpiece during transportation and/or during machining of at least one of the lateral faces of the workpiece.

5. The machining device as claimed in claim 1, wherein the machining of the workpiece on up to four lateral faces takes place by means of a planing installation and/or a four-side molder and/or trenching installation and/or router installation and/or sanding installation.

6. The machining device as claimed in claim 1, wherein the installation for applying material to the workpiece has a tape application installation by means of which at least one tape is capable of being applied to the workpiece.

7. The machining device as claimed in claim 6, the tape is an adhesive tape, in particular a one-sided or double-sided adhesive tape, or a masking tape.

8. The machining device as claimed in claim 1, wherein the installation for applying material has an installation by means of which a medium such as a primer and/or an adhesive, etc., is capable of being applied to the workpiece.

9. The machining device as claimed in claim 1, wherein a cleaning installation for cleaning the workpiece is disposed in the workpiece flow between the at least one tool and the installation for applying material.

10. The machining device as claimed in claim 6, wherein the cleaning installation has a blower nozzle, a suction installation, and/or a brush installation, etc.

11. The machining device as claimed in claim 1, wherein the tape application installation has a cross-cut installation for cross-cutting the tape.

12. The machining device as claimed in claim 1, wherein a workpiece storage installation for storing at least one workpiece or a plurality of workpieces is disposed in the workpiece flow between the at least one tool and the installation for applying material.

13. The machining device as claimed in claim 1, wherein the machining device has a machining width for the machining, in particular for planing and/or routing, such that a maximum workpiece width of 450 mm and/or a maximum machining thickness of 350 mm are/is possible.

14. The machining device as claimed in claim 1, wherein the workpieces to be machined are preferably bar-shaped workpieces, the workpiece width thereof being up to 300 mm and/or the thickness thereof being up to 150 mm.

15. A method for machining a workpiece by way of a machining device, in particular as claimed in claim 1, wherein, in which method a workpiece by means of at least one tool is subtractively contoured on at least one lateral face, and subsequently, in particular in the workpiece flow, a material is applied to the workpiece by means of an installation for applying material to the workpiece.

16. The method as claimed in claim 15, wherein cleaning takes place after the contouring, in particular prior to material being applied to the workpiece.

17. The method as claimed in claim 15, wherein storing the workpiece in a workpiece storage installation takes place after the contouring of a workpiece, wherein upon the retrieval of a workpiece a material is applied to the retrieved workpiece.
